(19) United States
(12) Patent Application Publication
(10) Pub. No.: US 2015/0070874 A1
(43) Pub. Date: Mar. 12, 2015

(54) Flameless fragrance warming apparatus and methods

(71) Applicants: Brian Beesley, Draper, UT (US); Spencer Beesley, Draper, UT (US)

(72) Inventors: Brian Beesley, Draper, UT (US); Spencer Beesley, Draper, UT (US)

(21) Appl. No.: 13/987,838

(22) Filed: Sep. 6, 2013

(51) Int. Cl. F21S 10/04; H05B 33/08

(52) U.S. Cl. CPC F21S 10/046; H05B 33/0803
USPC 362/96

(57) ABSTRACT

Warming apparatus by which aroma is released without combustion, and related methods, are disclosed which can be used safely, free of combustion and related pollution, to provide authentic visual imagery of a simulated candle flame, wherein a concealed heating source is substantially remotely spaced from and well below an exposed tower-mounted light source and flickering light is transmitted to the user through a spaced surrounding translucent chimney.

### FIELD OF INVENTION

The present invention relates generally to flameless fragrance warming apparatus, and related methods, for emitting fragrance or aroma and, more particular, to novel flameless warming apparatus, and related methods, which, without combustion, release aroma from a flameless candle, wax particles or oil into the ambient surroundings from a relatively low elevating, while also providing illumination which visually simulates a flickering flame eliminating from a relatively high elevation.

### BACKGROUND

In large measure, the burning of candles to emit an aroma or fragrance into the air within a home or other building has been replaced by flamelessly melting of a candle composition with an electrically powered heating element to release the aroma or by placing fragrance-containing wax chips or particles or oil in a flat bottom open top container with the bottom wall of the container disposed on an electrically-powered flat heating element. However, flameless release of aroma per se in the past failed to realistically simulate the flame of a burning candle. Thus, the prior does not substantially replicate the visual imagery of a candle flame, including a visual flicker. Typically, the heating element is positioned above or at the same elevation as the illumination source, which tends to obscure the light issuing from the source and makes flicker, when used, unrealistic, compared to the light from a burning candle. This includes embodiments where the heat and the light source or sources are at essentially the same elevation.

Also, replacement of burned out light source or sources is difficult because the light socket or sockets are concealed and not readily accessible. Rapid heat deterioration of the electrical circuit, the light sources and other components occurs and there is no provision by which the light source or sources, the electrical socket or sockets are cool during use to extend their length of service. Containment of the heat source and the light source within the main housing of prior art warmers retains both sources at a high temperature during use, with no provision by which cooling is allowed to take place.

Provision of flameless fragrance-emitting warming devices, and related methods, which address and resolve the problems mentioned above would be highly advantageous. The present invention does so.

### BRIEF SUMMARY AND OBJECTS OF THE INVENTION

In brief summary, the present invention provides warming apparatus by which aroma is released without combustion, and related methods, which can be used safely, free of combustion and related pollution, in either of two ways to release fragrance from a scented candle material or scented wax chips placed in a container or heating oil containing a fragrance, while at the same time, in a flameless context, providing authentic visual imagery of a simulated candle flame, wherein: (1) the heating source is substantially remotely spaced from and well below a pinnacle-mounted or tower-mounted light source; (2) the light source is air cooled outside the main housing, (3) flickering light is transmitted to the user through a spaced surrounding translucent chimney, which is removable to aid in light source replacement; (4) heat deterioration is material reduced; and (5) the fragrance-emitting material is well below the light source and in efficient communication with the heat source.

In view of the foregoing, it is a primary object of the present invention to provide improved candle and chip melting, oil heating and fragrance-emitting apparatus and methods, which also flamelessly simulates, in a very realistic way, the flicker of a burning candle.

It is a further paramount object to provide novel apparatus, and related methods, by which scented wax or chips are melted or scented oil warmed to emit a desirable fragrance or aroma and also provide illumination realistically simulating or replicating the burning of a candle, having one or more of the following characteristics: (1) the heat source is substantially remotely spaced from and well below a pinnacle-mounted or tower-mounted light source; (2) the light source is air cooled outside the main housing (3) flickering light is transmitted to the user through a spaced surrounding translucent chimney, which is removable to aid in light source replacement; (4) heat deterioration is material reduced and (5) the fragrance-emitting material is well below the light source and in efficient communication with the heat source.

This and other objects and features of the present invention will be apparent from the following detailed description taken with reference to the accompanying drawings.

### BRIEF DESCRIPTION OF THE DRAWINGS

FIG. 1 is a perspective of one presently preferred apparatus for practicing the present invention;

FIG. 2 is an exploded perspective, partially in cross section, of the apparatus of FIG. 1, the apparatus being used to flamelessly emit fragrance and simultaneously visually issue a flicker of light from an elevated site, which authentically simulates a burning candle;

FIG. 3 is a vertical cross section through the housing of the apparatus of FIG. 1;

FIG. 4 is a fragmentary cross section of a second embodiment of the present invention; and

FIG. 5 is a circuit diagram of a presently circuit for causing one or more light sources, located at the top of an exposed pedestal, to flicker.

### DETAILED DESCRIPTION OF THE ILLUSTRATED EMBODIMENTS

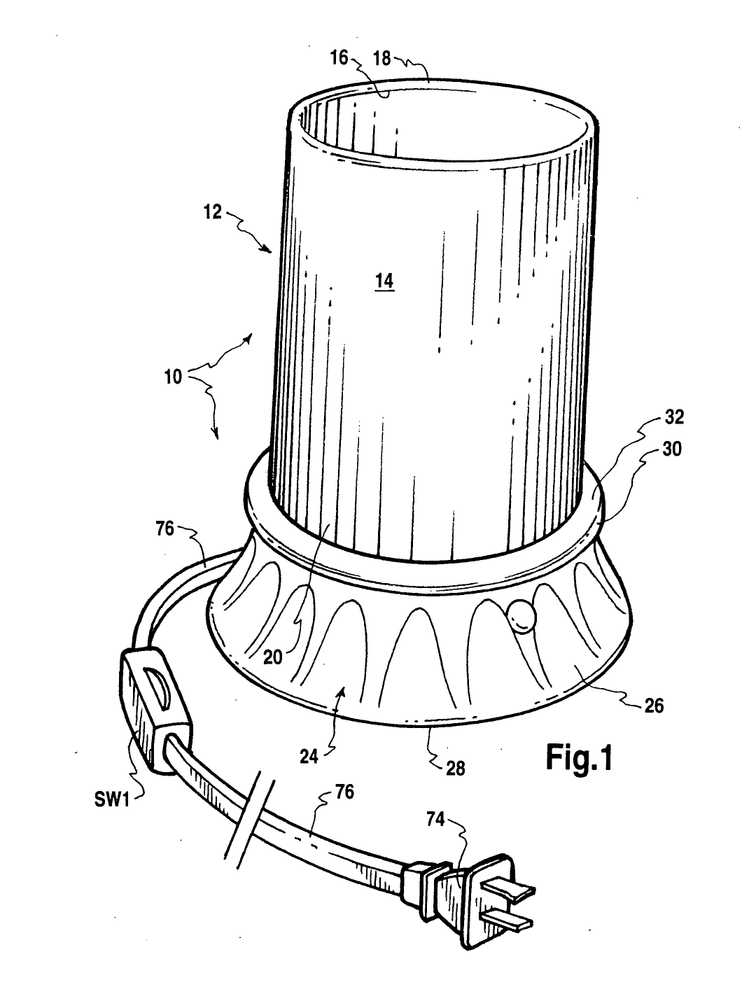

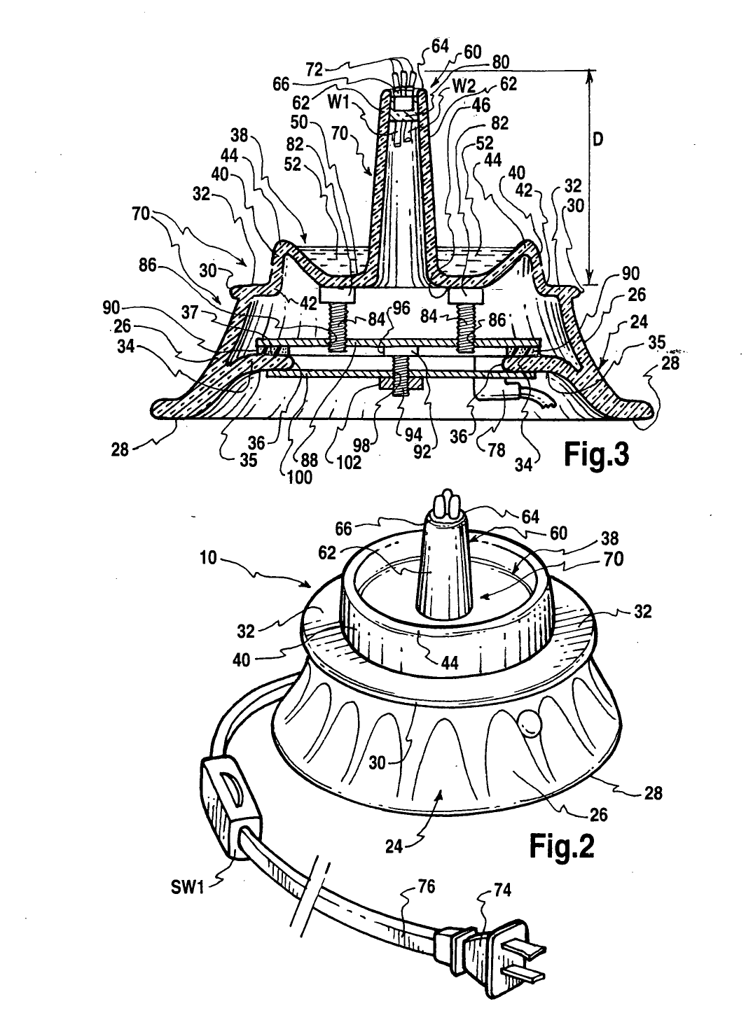

Reference is now made specifically to the drawings, wherein presently preferred apparatus embodiments are disclosed. Reference is made to FIGS. 1-3, which concerns a presently preferred apparatus, generally designated 10. The apparatus 10 comprises an annually-removable translucent chimney, generally designated 12, comprising a uniformly cylindrical wall 14, having a hollow interior with an upper edge 18, through which aroma or fragrance is emitted in a manner hereinafter more fully described. The chimney 12 further comprises a lower end 20, defining an annular lower edge 22 (FIG. 2), which rests by force of gravity upon a flat support surface, hereinafter more fully described. The chimney 12 may be formed of glass, synthetic resinous material or any other suitable material.

The apparatus 10 further comprises a surface-engaging lower base, generally designated 24. The base 24 may comprise an exterior decorative exposed surface of a tapered side wall 26. The side wall 26 terminates in an annular surface-engaging foot 28. The base 24 comprises a top lip 30 disposed at the upper end of the side wall 26. The lip 30 integrally merges with a horizontal shoulder or shelf 32, upon which the lower edge 22 of the chimney 12 rests, when the apparatus is fully assembled in its usable state.

The base 24 is interiorly hollow and comprises an annular internal ring or shoulder 34, which is radially inwardly directed and defines a central, relatively large circular opening at 36. FIG. 3.

Integral with the base 24 is structure which defines a reservoir, generally designated 38 (FIGS. 2 and 3). Reservoir 38 is confined by an upwardly directed but somewhat inwardly tapered side wall 40, the lower end of which, at annular shoulder or corner 42, merges with shoulder 32, extending upwardly to an elevated ring or annular lip 44.

A downwardly directed U-shaped wall 50, annular in configuration, connects with lip 44 and extends inwardly. The wall 50 to help define a donut-shaped reservoir 52, in which a fragrance emitting material, such as candle material wax particles or aroma-releasing oil 52 is placed.

The interior of the reservoir 52 is further defined by an upwardly tapered frusto-conical pedestal, pinnacle or tower, generally designated 60. The pedestal 60 comprises a vertically tapered but horizontally curvilinear wall 62, which extends a substantial distance upward so that the top edge 64 thereof is at an elevation much higher than the elevation of the reservoir 52. Thus, the top of the pedestal 60 is remote from the reservoir 52. The top edge 64 of the pedestal 62 defines a small diameter opening 66.

While the base, the base-reservoir defining structure and the pedestal are shown as comprising a single one-piece structure, the present invention embraces forming such structure as two or more pieces. While the housing 24, the structure defining reservoir 52 and the pedestal 60 may be formed of ceramic material, as shown in the drawings, other suitable material may be utilized, all to the end that the upper end of the pedestal is open to and cooled by ambient air and remotely disposed from the fragrance material in the reservoir 52 for purposes yet to be explained in greater detail. While the reservoir 52 is at a first lower elevation and the upper edge 64 of the pedestal 60 is at a second much higher elevation, so as to resemble somewhat the appearance of a lighthouse, the upper edge 18 of the chimney 12 is at still a higher third elevation. Thus, the chimney 12 conceals from direct view the upper edge 64 of the pedestal 60, when the apparatus is assembled as illustrated in FIG. 1.

The integrated base 24, the structure defining the reservoir 52 and the pedestal 60 are collectively referred to herein as a housing, which is generally designated 70. The housing 70 is hollow in its interior to accommodate placement of wiring for powering one or more heating elements and to power the flickering lights, as described later in greater detail.

In reference to FIG. 3, one or more sources of illumination 72 are disposed in electrical sockets so as to be exposed slightly above the upper end 64 of the pedestal 60, remote from the fragrance emitting material in reservoir 52. Thus, the heat from the heaters of the apparatus 10 has no deleterious effect on the lights. While the light source or sources 72 may be incandescent lights, it is presently preferred that light emitting diodes (LEDs) be used. Each light source 74 is removably placed in an electrical socket with electricity being delivered to each socket using wires W1 and W2. Such electricity is available in household sockets as 120 volt AC conducted to plug 74 and along conductors contained in sheath 76 to the interior of the housing 70 at site 78 (FIG. 3) and thence along conductors W1 and W2. A switch SW1 accommodates turning on and shutting off the electricity. When the switch SW1 is on and plug 74 in a household socket, the light sources 72 are illuminated in a pulsating or flickering fashion, causing light to be periodically transmitted through the translucent wall 14 so as to realistically and authentically resemble the light viewed when a candle burns, but namelessly without combustion.

The socket or sockets for the light sources or source 72 are secured in the position, illustrated in FIGS. 2 and 3 by a suitable anchor plug 80, which may be a bonding agent placed snuggly in the hollow interior 66 adjacent to upper end 64 of the pedestal 60.

While one heating element may be utilized, two heating elements 82 are illustrated in FIG. 2, to which household electricity is delivered, when the switch SW1 is on. Essentially, the heaters 82 are commercially available resistors. Each heater 82 is held in contiguous heat-communicating relation with the reservoir wall 50, at the bottom surface thereof. Consequently, when the heaters 82 are on, heat conductively passes through the wall 50 to melt and warm the candle material or wax particles in the reservoir or to warm scented oil contained therein, as the case may be, thereby causing aroma from the fragrance-emitting material to elevate up the chimney and out adjacent to the top edge 18 into the ambient atmosphere rounding the apparatus 10.

Each heater 82 is secured in its position by a vertical threaded shaft 84. Each threaded shaft 84 passes through a threaded aperture in steel bar 88, such that the threaded shafts 84 may be rotated in threaded apertures 86 of the bar until the respective heaters 82 rest firmly contiguous against the lower surface of wall 50.

The steel bar 88 is of narrow rectangular construction and is planar as to be disposed in a plane above but essentially parallel to support structure 28, usually horizontal. Bar 88 is of a size such that it can readily be placed through the opening 36 and positioned to rest upon spaced flat rectangular cushioning seals 90, so that the bar 88 is spaced from the annular wall 35, with the circular opening 36 accommodating facile insertion of the bar 88. The head 92 of a threaded bolt 94 is welded at 96 to the underside of the crossbar 88 so that the bolt extends downwardly loosely through an aperture 98 in a base plate 100, the base plate 100 being essentially spaced from but parallel to the crossbar 88. The plate 100 is circular in its configuration so that it continuously and contiguously presses against the bottom surface of the wall 35 and is held in this position by a nut 102 threaded tightly upon the threaded shaft 94 to rigidly secure the heaters 82, the threaded shafts 84, the bar 88 and the plate 100 in stable relation, while allowing removal of the nut 102 to disassemble, when and if necessary.

Reference is now made to the circuit drawing of FIG. 5. 120 volt alternating current from a household source is caused to be available across switch SW1 on live wire or conductor W1, with wire or conductor W2 serving as a ground wire. Resistor R1 represents heaters 82, and directly uses the 120 v AC to melt scented candle wax or fragrance-emitting particles or to heat oil, to release an aroma. Capacitor C1 in conjunction with resistor R1 provides failure protection for the heater. Diodes D1 through D4 function as a transformer to transform 120 v AC power into low voltage DC power for illuminating LED lights LED1 through LED3. DZ1, in conjunction with compacitor C2, provide fail safe protection for the LEDs. All electrical components are preferably mounted on a PC board.

The flicking occurs at the LED lights (LED1 through LED3). Each has a commercially available build-in integrated circuit to perform the flickering function by sending a command signal, on a certain frequency, to the LED light bulbs.

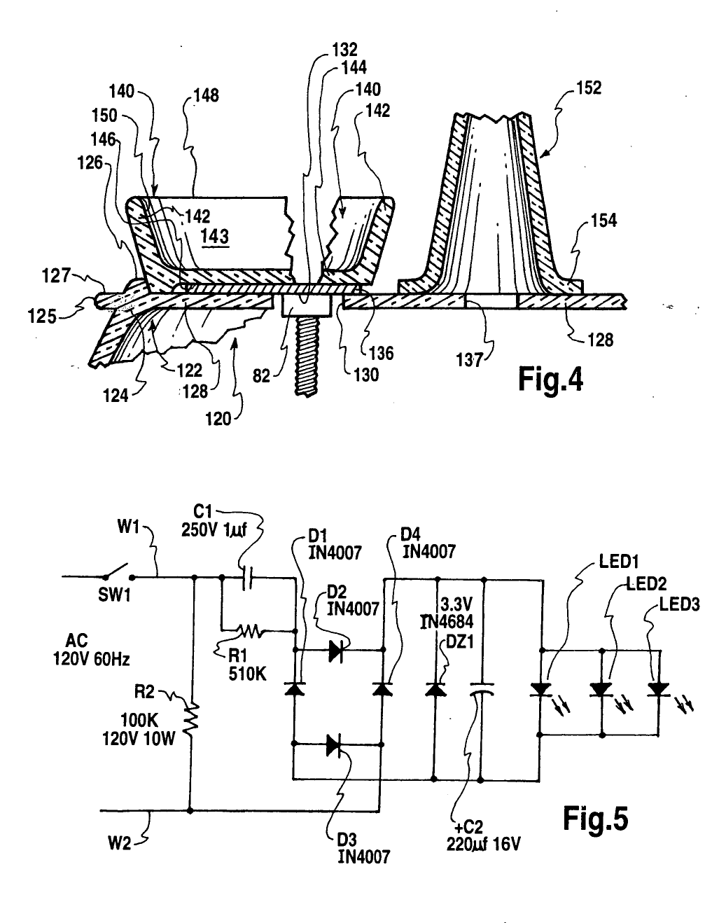

Reference is now made to FIG. 4, which, unless otherwise stated hereinafter, is constructed as heretofore set forth in respect to apparatus 10 of FIGS. 1-4. The embodiment of FIG. 4 is referred to generally by the numeral 120. The FIG. 4 scented material warmer 120 comprises a base generally designated 122, comprising a tapered side wall 124 terminating in an upwardly directed annular lip 126. Annular shelf or shoulder 125 extends horizontally and radially outwardly from and integral with wall 125, such that a top surface 127 of the shelf 125 contiguously but removably receives the lower edge 22 of the chimney 12, when the apparatus 120 is fully assembled and in operable condition. The base 122, at an elevation slightly below the annular lip 126, comprises a flat wall 128 having spaced apertures 130 disposed therein, only one aperture 130 being illustrated in FIG. 4. Horizontal wall 128 is integral with side wall 124. Apertures 130 accommodate insertion of the previously described heaters 82 into firm contiguous relation with the lower surface 132 of a metal heating plate 134, so that the heaters 82 conduct heat across the plate 132, which is annular in its configuration, the heating plate 134 comprises a central aperture 136, accommodating placement of a light source tower or pedestal 152. Wall 128 comprises a central opening 137 therein through which conductors W1 and W2 pass to supply power to the light sources at the top of pedestal 152.

The apparatus 120 comprises removable annularly-shaped dish, generally designated 140. The dish 140 is of one piece construction, which comprises an outwardly tapered, vertically extending wall 142 having an internal surface 143, a bottom wall 144 comprising a bottom surface 146 extending generally in a horizontal direction and disposed contiguous with the heating plate 134. The dish or container 140 comprises a top lip 148, which defines an opening at top 150. A downwardly extending support ring 151 rests upon wall 128 and provides an annular space support sized to receive heating plate 134 contiguously beneath the bottom 144 of dish 140 and the top surface of wall 128.

A pedestal, generally designated 152, is removable, but, in the assembled position, comprises an annular support foot 154, which stably supports the pedestal 152 upon the top surface of wall 128. The remainder of the pedestal 152 is preferably identical to pedestal 60 of apparatus 10; described above.

The invention may be embodied in other specific forms without departing from the spirit or essential characteristics thereof. The present embodiments are, therefore, to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A light-emitting apparatus for releasing fragrance from warmed material comprising candle material or wax particles or oil, without combustion, the apparatus comprising:
a hollow housing comprising a base adapted to be supported on a surface;
an open reservoir in which fragrance-emitting material is placed, the reservoir being carried by the housing at a first elevation;
an upwardly-extending exposed tower held in an elevated position having at least one exposed light source at a second elevation which is substantially above the first elevation;
at least one source of heat concealed within the hollow of the housing in isolation and remote from the light source, but in heat communication with the reservoir and fragrance-emitting material therein;
a fragrance-conducting translucent chimney removably resting on the housing and extending to an elevation substantially higher than the second elevation;
circuitry by which electric energy, when activated, is delivered to at least one light source causing the light source to flicker, thereby delivering pulsating illumination which visually passes through the chimney as an accurate replication of a burning candle.

2. An apparatus according to claim 1 wherein the housing is of one piece construction.

3. An apparatus according to claim 1 wherein the housing comprises more than one separate parts.

4. An apparatus according to claim 1 wherein the chimney surrounds the tower and the light sources.

5. An apparatus according to claim 1 wherein the reservoir is annular-shaped and surrounds the tower.

6. An apparatus according to claim 1 wherein the housing is free of light communicating apertures.

7. An apparatus according to claim 1 wherein the housing comprises ceramic material.

8. An apparatus according to claim 1 wherein the at least one light sources comprises at least one incandescent light source.

9. An apparatus according to claim 1 wherein the at least one light source comprises at least one light emitting diode.

10. An apparatus according to Claim I wherein the at least one source of heat is concealed within the housing and the at least one light source is external of the housing.

11. A method of flamelessly emitting an aroma into ambient air comprising the acts of:
heating contained aroma-emitting material at a first lower elevation to cause release of the aroma from the material;
directing the released aroma upwardly in a translucent chimney into surrounding ambient air;
generating a light flicker at a second higher elevation within the chimney, the second higher elevation being remote from the first lower elevation;
directing the light flicker through the translucent chimney as an accurate replication of a burning candle;
generally obliterating visual observation of the light flicker at an open top of the chimney by locating the chimney top at a third elevation substantial above the second elevation.
